(19) United States
(12) Patent Application Publication
(10) Pub. No.: US 2017/0262887 A1
(43) Pub. Date: Sep. 14, 2017

(54) METHOD AND SYSTEM FOR DELIVERING TARGETED ADVERTISEMENTS ASSOCIATED WITH A PAYMENT PARKING SYSTEM

(71) Applicant: ANAND VAIDYANATHAN, CHENNAI (IN)

(72) Inventor: ANAND VAIDYANATHAN, CHENNAI (IN)

(21) Appl. No.: 15/088,142

(22) Filed: Apr. 1, 2016

(30) Foreign Application Priority Data
Mar. 11, 2016 (IN) 201641008576

(51) Int. Cl. G06Q 30/02

(52) U.S. Cl. CPC G06Q 30/0259; G06Q 30/0266; G06Q 30/0267; G06Q 30/0269

(57) ABSTRACT

A user targeted advertisement delivery system for delivering one or more targeted advertisements to the user is provided. The system includes a parking server that receives the user parking related information from the user device and one or more advertisements from the one or more advertiser devices. The parking server identifies and serves one or more targeted advertisements based on a location of parking, a time of day, a day of week, a calendar, and a duration of parking. The parking server communicates a notification (e.g., a parking receipt, reminders for timer expiry, thank you note once the time is over) along with one or more targeted advertisements to the user device when the user initiates a parking timer after parking his/her vehicle in a parking slot.

### BACKGROUND

Technical Field

Embodiments of this disclosure generally relate to an advertisement, and more particularly, to a system and method of delivering targeted advertisements to user devices assisted with a payment parking system.

Description of the Related Art

In the modern era of private transport people move around in their private vehicles to go to the movies, restaurants, downtown areas, malls and other places. People often park their cars in areas designated by the county or municipality as parking areas. Such parking is often paid parking.

Within an urban environment, local government generally regulates parking at curbside on public roads, in municipal parking lots, and on other public property through a regulatory scheme that both provides revenue generation and promotes public safety and health. Commonly, public parking is regulated through a scheme of fees assessed through parking meters for fixed time period parking, by issuance of permits for residential, commercial, or special use parking, and through zoning that regulates permissible uses of property, including parking. Parking on privately-owned property is often offered through hourly fees or some form of parking contract.

At the same time local business have a need to reach out and advertise their products/services and deals. They need to do this in order to do further their businesses and for business visibility. However this advertisement needs to be targeted to users in order to be effective and efficient. The targeting of the advertisements need to be such that it is done to the right people and at the right time and place. It would be advantageous to both the advertiser and the users to provide advertisements that are directed to the end users and encourage action by the end users.

Accordingly, there remains a need for a system and method for delivering one or more targeted advertisements by local businesses to promote their products or services to the people nearby through a mobile payment system.

### SUMMARY

In view of the foregoing, an embodiment herein provides a user targeted advertisement delivery system for delivering one or more targeted advertisements to a user device, through a parking server. The parking server includes a memory unit, and a processor. The memory unit that stores (a) a set of modules, and (b) a database. The processor which executes the set of modules. The set of modules includes a user parking information receiving module, a location and time specific advertisement information receiving module, a micro and macro location identification module, a targeted advertisement determining module and a targeted advertisement notification communicating module. The user parking information receiving module, executed by the processor, configured to receive a user parking information related to occupancy of a parking slot by a user device. The user parking information includes (a) a location of said parking slot and lot that is occupied, and/or a location of user device, (b) a time at which the user occupies the parking slot, and (c) a profile of a user. The location and time specific advertisement information receiving module, executed by the processor, configured to receive the one or more advertisements from one or more advertiser devices. The one or more advertisements comprise advertisement information selected based on at least one of (i) a micro and macro location, (ii) a time of a day, (iii) a day of a week, and (iv) calendar event at which the one or more advertisers prefer to deliver the one or more advertisements, and (v) duration of parking. The parking server includes an advertisement database that is configured to categorize the one or more advertisements based on the location at which the one or more advertisers prefer to deliver the one or more advertisements and store the one or more advertisements. The micro and macro location identification module, executed by the processor, configured to identify one or more micro and macro locations by analyzing a map. In one embodiment, the map is stored in the parking server. The targeted advertisement determining module, executed by the processor, configured to determine the one or more targeted advertisements to the user device based on (i) the location of the user device, or the location of a parking lot and slot that is occupied, and at least one of (a) the one or more micro and macro locations, (b) the time at which the user device occupies the parking slot, (b) the profile of the user, and (ii) the micro and macro location at which the one or more advertisers prefer to deliver the one or more advertisements, and at least one of (a) the time of the day, (b) the day of the week, (c) the calendar event at which the one or more advertisers prefer to deliver the one or more advertisements, and (d) duration of parking selected. The targeted advertisement notification communicating module, executed by the processor, configured to communicate a notification with the one or more targeted advertisements to the user device.

In one embodiment, the user device includes a memory unit, and a processor. The memory unit that stores (a) a set of modules, and (b) a database. The processor which executes the set of modules. The set of modules includes a parking timer module, a user parking information communicating module and a targeted advertisement notification receiving module. The parking timer module, executed by the processor, configured to select a parking duration from a parking timer by a user in the user device. The parking timer includes at least one of (i) parking timer blocks, and/or (ii) a start/stop timer to select the parking duration by the user after parking his/her vehicle in a parking slot. The user parking information communicating module, executed by the processor, configured to communicate user parking information related to occupancy of the parking slot by the user device to the parking server. The user parking information includes (a) the location of the parking lot and slot that is occupied, and/or the location of user device, (b) the time at which the user occupies the parking slot, and (c) the profile of the user. The targeted advertisement notification receiving module, executed by the processor, configured to receive the welcome notification of the one or more targeted advertisements in the user device from the parking server when the parking duration block is selected by the user.

In another embodiment, the user targeted advertisement delivery system is configured in the one or more advertiser devices. The system includes a memory unit, and a processor. The memory unit that stores (a) a set of modules, and (b) a database. The processor which executes the set of modules. The set of modules includes a location and time specific advertisement information communication module that is configured to communicate the one or more advertisements to the parking server.

In one aspect, a user targeted advertisement delivery system for delivering the one or more targeted advertisements to a user device, through a parking server is provided. The system includes a memory unit, and a processor. The memory unit that stores (a) a set of modules, and (b) a database. The processor which executes the set of modules. The set of modules includes a parking timer module, a user parking information communicating module, a user parking information receiving module, a location and time specific advertisement information receiving module, a micro and macro location identification module, a targeted advertisement determining module, a targeted advertisement notification communicating module, and a targeted advertisement notification receiving module. The parking timer module, executed by the processor, configured to select a parking duration from a parking timer by a user in the user device. The parking timer includes at least one of (i) parking time blocks, and/or (ii) a start/stop timer to select the parking duration by the user after parking his/her vehicle in a parking slot. The user parking information communicating module, executed by the processor, configured to communicate user parking information related to occupancy of the parking slot by the user device to the parking server. The user parking information includes (a) a location of the parking slot or lot that is occupied and/or location of user device, (b) a time at which the user occupies the parking slot, and (c) a profile of the user. The user parking information receiving module, executed by the processor, configured to receive the user parking information related to occupancy of the parking slot by the user device. The location and time specific advertisement information receiving module, executed by the processor, configured to receive one or more advertisements from one or more advertiser devices. The one or more advertisements comprise advertisement information selected from at least one of (i) a micro and macro location, (ii) a time of a day, (iii) a day of a week, (iv) a calendar event at which the one or more advertisers prefer to deliver one or more advertisements, and (v) duration of parking. The parking server includes an advertisement database that is configured to categorize the one or more advertisements based on the micro and macro location at which the one or more advertisers prefer to deliver the one or more advertisements and store the one or more advertisements. The micro and macro location identification module, executed by the processor, configured to identify one or more micro and macro locations by analyzing a map. In one embodiment, the map is stored in the parking server. The targeted advertisement determining module, executed by the processor, configured to determine the one or more targeted advertisements to the user device based on (i) the location of the user device, and/or the location of parking lot and slot that is occupied, and at least one of (a) the one or more micro and macro locations, (b) the time at which the user device occupies the parking slot, and (b) the profile of the user, and (ii) the micro and macro location at which the one or more advertisers prefer to deliver the one or more advertisements, and at least one of (a) the time of the day, (b) the day of the week, (c) the calendar event at which the one or more advertisers prefer to deliver the one or more advertisements, and (d) duration of parking. The targeted advertisement notification communicating module, executed by the processor, configured to communicate a notification with the one or more targeted advertisements to the user device. The targeted advertisement notification receiving module, executed by the processor, configured to receive the notification of the one or more targeted advertisements in the user device from the parking server when the parking duration is selected by the user.

In one embodiment, the user targeted advertisement delivery system is configured in the one or more advertiser devices. The system includes a memory unit, and a processor. The memory unit that stores (a) a set of modules, and (b) a database. The processor which executes the set of modules. The set of modules includes a location and time specific advertisement information communication module that is configured to communicate the one or more advertisements to the parking server.

In another embodiment, the location of the user device is determined based on at least one of (a) a global positioning system (GPS) associated with the user device, and (b) a location information associated with the parking slot that is occupied by the user.

In yet another embodiment, the location and time specific advertisement information communication module communicates the one or more advertisements in real-time to the parking server.

In yet another embodiment, the location and time specific advertisement information communication module updates the one or more advertisements in real-time to the parking server.

In another aspect, a method for delivering one or more targeted advertisements to a user device, the method for delivering the one or more targeted advertisements to the user device includes the following steps of (I) selecting, a parking duration from a parking time blocks in the user device by a user select after parking his/her vehicle in a parking slot, (II) communicating, using the user device, user parking information related to occupancy of the parking slot to a parking server. The user parking information includes (a) a location of the user device, and/or a location of parking lot or slot that is occupied, (b) a time at which the user occupies the parking slot, and (c) a profile of the user, (III) receiving, using the parking server, the user parking information related to occupancy of the parking slot from the user device, (IV) receiving, using the parking server, one or more advertisements from one or more advertiser devices. The one or more advertisements includes the advertisement information selected from at least one of (i) a micro and macro location, (ii) a time of a day, (iii) a day of a week, (iv) a calendar event, and (v) a parking time block or a duration of parking selected at which one or more advertisers prefer to deliver the one or more advertisements, (V) storing, at the parking server, one or more advertisements. The one or more advertisements are categorized based on the micro and macro location at which the one or more advertisers prefer to deliver the one or more advertisements, (VI) identifying, at the parking server, one or more micro and macro locations by analyzing a map that is stored in the parking server, (VII) determining, at the parking server, the one or more targeted advertisements for the user based on (i) the location of the user device, and at least one of (a) the one or more micro and macro locations, (b) the time at which the user device occupies the parking slot, and (b) the profile of the user, and (ii) the micro and macro location at which the one or more advertisers prefer to deliver one or more advertisements, and at least one of (a) the time of the day, (b) the day of the week, (c) the calendar event at which the one or more advertisers prefer to deliver one or more advertisements, and (d) a parking time block or a duration of parking selected, (VIII) communicating, using the parking server, a notification with the one or more targeted advertisements to the user device, and (IX) receiving, using the user device, the notification with the one or more targeted advertisements from the parking server when the user selects the parking duration.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of one or more advertiser devices deliver one or more targeted advertisements to a user device through a parking server using a user targeted advertisement delivery system according to an embodiment herein;

FIG. 2 illustrates an exploded view of the user targeted advertisement delivery system configured in the user device of FIG. 1 according to an embodiment herein;

FIG. 3 illustrates an exploded view of the user targeted advertisement delivery system configured in the parking server of FIG. 1 according to an embodiment herein;

FIG. 4 illustrates an exploded view of the user targeted advertisement delivery system configured in the one or more advertiser devices of FIG. 1 according to an embodiment herein;

FIG. 5 illustrates an user interface view of a targeted advertisement notification receiving module configured in the user device of FIG. 1 according to an embodiment herein;

FIG. 6 illustrates an user interface view of a location and time specific advertisement information communication module configured in the one or more advertiser devices of FIG. 1 according to an embodiment herein;

FIG. 7 is a flow diagram illustrating a method of delivering one or more targeted advertisements to a user device through a parking server using a user targeted advertisement delivery system according to an embodiment herein;

FIG. 8 illustrates an exploded view of a personal communication device according to the embodiments herein; and

FIG. 9 a schematic diagram of computer architecture used in accordance with the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

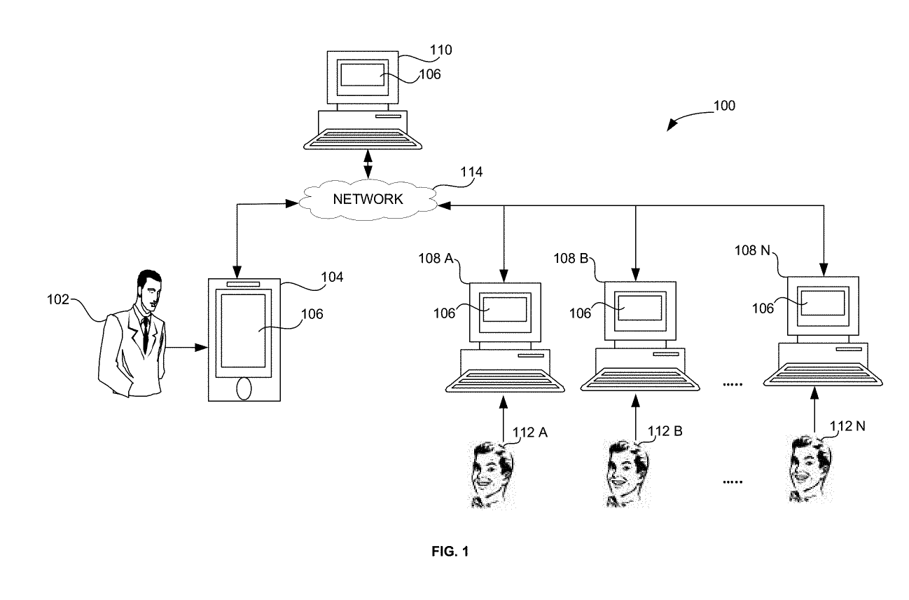

As mentioned, there remains a need for a system and method for delivering one or more targeted advertisements by local businesses to promote their products or services to the people nearby through a payment parking system. The embodiments herein achieve this, by providing a user targeted advertisement delivery system for delivering one or more targeted advertisements to a user device through a parking server. Referring now to the drawings, and more particularly to FIG. 1 through FIG. 9, where similar reference characters denote corresponding features consistently throughout the figures, there are shown preferred embodiments.

FIG. 1 illustrates a system view 100 of one or more advertiser devices 108A-N deliver one or more targeted advertisements to a user device 104 through a parking server 110 using a user targeted advertisement delivery system 106 according to an embodiment herein. The system view 100 includes a user 102, the user device 104, the user targeted advertisement delivery system 106, the one or more advertiser devices 108A-N, the parking server 110, one or more advertisers 112A-N, and a network 114. The user device 104, the one or more advertiser devices 108A-N and the parking server 110 includes the user targeted advertisement delivery system 106.

When the user 102 parks his/her vehicle in a parking slot and select a parking duration from a parking timer in the user device 104. The parking timer includes at least one of (i) parking time blocks, and (ii) a start/stop timer to select the parking duration. The user related information is communicated to the parking server 110 using the user targeted advertisement delivery system 106 in the user device 104 via the network 114. The user targeted advertisement delivery system 106 sends one or more targeted advertisements to the user device 104 through the parking server 110 via the net work 114, based on a location of the user device 104, a time at which the user device 104 occupies the parking slot and a profile of the user device 104. In one embodiment, the user targeted advertisement delivery system 106 sends one or more targeted advertisements to the user device 104 through the parking server 110, via the network 114 based on a micro or macro location at which the one or more advertisers 112A-N prefer to deliver one or more targeted advertisements to the user device 104. In another embodiment, the user targeted advertisement delivery system 106 sends one or more targeted advertisements to the user device 104 through the parking server 110 via the network 114, based on a location of parking, a time of a day, a day of a week, a calendar event, at which the one or more advertisers 112A-112N prefer to deliver one or more targeted advertisements to the user device 104 and a duration of parking time. For example, when the user 102 parks his/her vehicle in a parking slot and select a parking duration of 15 minutes block at lam in the morning, the targeted advertisement delivery system 106 determines a probable intent of the user 102 to pick up a food to eat, or a medicine, and delivers the one or more targeted advertisements related to medical shop, or drive in restaurant. In one embodiment, the micro-location refers to a close proximity area to the user 102, i.e. for example less than 5 kilometers (<5 km). In another embodiment, the macro-location refers to a wider area or a corporation or a city at which the user 102 resides.

In one embodiment, the user device 104 is enabled with Global Positioning System (GPS) related source. In another embodiment, the user device 102 may be a wireless mobile communication device, such as a cell phone, smart phone, tablet or personal digital assistance (PDA). In another embodiment, the one or more advertiser devices 108A-N may be a personal computer (PC), a handheld PC, a laptop, a smart phone, tablet, a mobile device, a net book, a personal digital assistant (PDA). In yet another embodiment, the parking server 110 may be a personal computer (PC), a handheld PC, a laptop, LAN, WLAN, wireless or wired network.

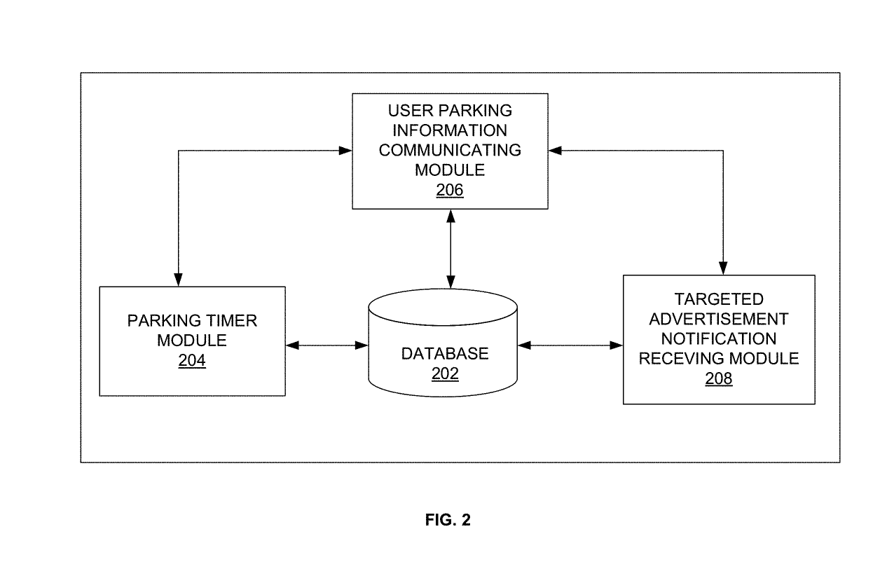

FIG. 2 illustrates an exploded view of the user targeted advertisement delivery system 106 configured in the user device 104 of FIG. 1 according to an embodiment herein. The user targeted advertisement delivery system 106 of the user device 104 includes a database 202, a parking timer module 204, a user parking information communicating module 206 and a targeted advertisement notification receiving module 208. The parking timer module 204 is configured to select a parking duration from a parking timer by the user 102 in the user device 104. The parking timer includes at least one of (i) parking time blocks, and (ii) a start/stop timer to select the parking duration by the user 102 after parking his/her vehicle in the parking slot. In one embodiment, the parking timer includes parking time blocks to be selected by the user 102. The parking timer blocks includes various blocks of time durations from 5 minutes to 1 hour, 2 hour, 3 hours, etc. In another embodiment, the parking timer is a start/stop timer. The user parking information communication module 206 is configured to communicate a user parking information to the parking server 110 via the network 114. The user parking information is related to occupancy of the parking slot by the user 102 from the user device 104. The user parking information includes (a) a location of the user device 104, and/or a location of the parking slot and lot that is selected for parking, (b) a time at which the user occupies the parking slot, and (c) a profile of the user. In one embodiment, the location information of the user device 104 is communicated to the parking server 110 using the GPS related source associated with the user device 104. The targeted advertisement notification receiving module 208 is configured to receive a note (e.g., parking receipt, reminders for timer expiry, thank you note once the time is over) with the one or more targeted advertisements from the parking server 110 to the user device 104, when the parking duration is selected by the user 102. In one embodiment, the one or more targeted advertisements received from the parking server 110 are in the form of messages, ads with hyperlinked texts, graphical images and similar.

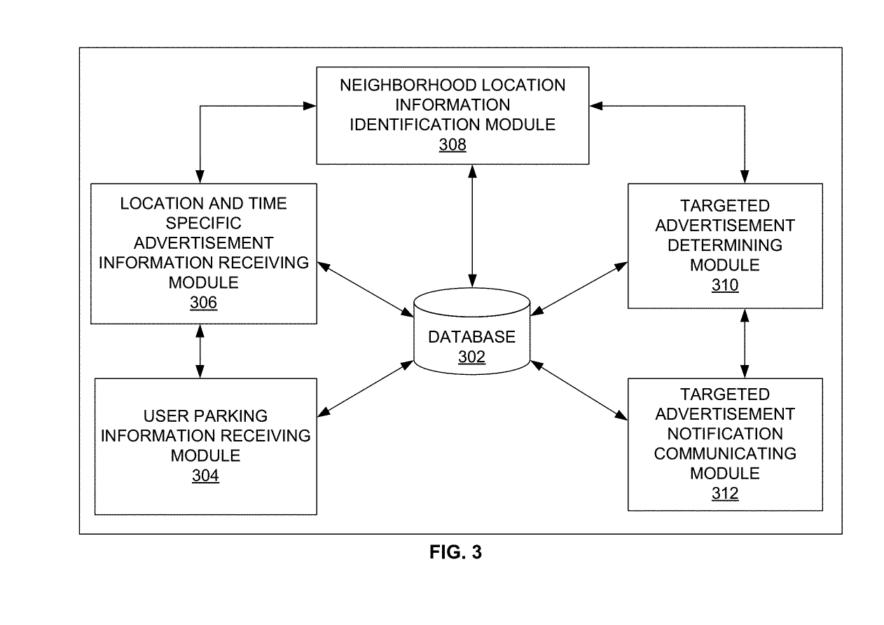

FIG. 3 illustrates an exploded view of the user targeted advertisement delivery system 106 configured in the parking server 110 of FIG. 1 according to an embodiment herein. The user targeted advertisement delivery system 106 of the parking server 110 includes an advertisement database 302, a user parking information receiving module 304, a location and time specific advertisement information receiving module 306, a micro and macro location information identification module 308, a targeted advertisement determining module 310 and a targeted advertisement notification communication module 312. The user parking information receiving module 304 is configured to receive the user parking information related to occupancy of the parking slot by the user 102 from the user device 104. The user parking information includes (a) the location of the user device 104 and/or the location of slot and lot that is occupied, (b) the time at which the user occupies the parking slot, and (c) the profile of the user. The location and time specific advertisement information receiving module 306 is configured to receive the one or more advertisements from the one or more advertiser devices 108A-N. The advertisement information includes at least one of (i) a micro and macro location, (ii) a time of a day, (iii) a day of a week. (iv) a calendar event at which the one or more advertisers 112A-N prefer to deliver one or more advertisements, (v) a duration of parking that is selected. In one embodiment, one or more advertisements are categorized based on the micro and macro location at which the one or more advertisers 112A-N prefer to deliver one or more advertisements to the user device 104 and stored in the advertisement database 302.

The micro and macro location information identification module 308 is configured to identify one or more micro and macro locations of the user 102, by analyzing a map. In one embodiment, the map is stored in the advertisement database 302. The targeted advertisement determining module 310 is configured to determine one or more targeted advertisements to the user device 104 based on (i) the location of the user device and/or the location of lot and slot that is selected for parking, and at least one of (a) the one or more micro and macro locations, (b) the time at which the user device occupies the parking slot, (b) the profile of the user, and (ii) the micro and macro location at which the one or more advertisers prefer to deliver the one or more advertisements, and at least one of (a) the time of the day, (b) the day of the week, (c) the calendar event at which the one or more advertisers prefer to deliver the one or more advertisements, and (d) the duration of parking block that is selected.

In one embodiment, the targeted advertisement determining module 310 is configured to determine one or more targeted advertisements to the user device 104 based on the duration of parking that is selected. For example, when the user 102 of about 18-30 years old from profile, parks his/her vehicle in a downtown area on Saturday, after 10 pm for more than an hour, the targeted advertisement determining module 310 automatically determines a probable intent of the user 102 is go to night clubs and identifies the one or more targeted advertisements related to night clubs to deliver to the user 102.

In another example, when the user 102 parks his/her vehicle in a parking slot and select a parking duration of 15 minutes block at lam in the morning, the targeted advertisement determining module 310 determines a probable intent of the user 102 to pick up a food to eat, or a medicine and identifies the one or more targeted advertisements related to medical shop, or a hotel to deliver to the user 102.

In yet another example, when the user 102 parks his/her vehicle in a city center at 12.00 pm to 2.00 pm on weekdays for more than an hour, the targeted advertisement determining module 310 automatically determines a probable intent of the user 102 is to go for a business lunch, or a restaurant and determines the one or more targeted advertisements related to a business lunch, or a restaurant to deliver to the user 102.

In yet another example, when the user 102 parks his/her for 10 minutes, the targeted advertisement determining module 310 automatically determines a probable intent of the user 102 is not to go for extensive shopping and determines the one or more targeted advertisements related to apparel shopping a.

In yet another embodiment, the targeted advertisement determining module 310 is configured to determine one or more targeted advertisements to the user device 104 based on a) demographic location, b) micro- or macro-location of the user 102. For example, a restaurant (i.e. one or more advertisers 112A-N) may advertise in a 5 km radius (Micro-Location) for all the parking slots. However Ford as a pickup truck manufacturer in an agricultural based state like Kansas, US may advertise within the state (Macro-location) across all parking slots. The targeted advertisement notification communicating module 312 is configured to communicate a note with one or more targeted advertisements targeted to the user device 104.

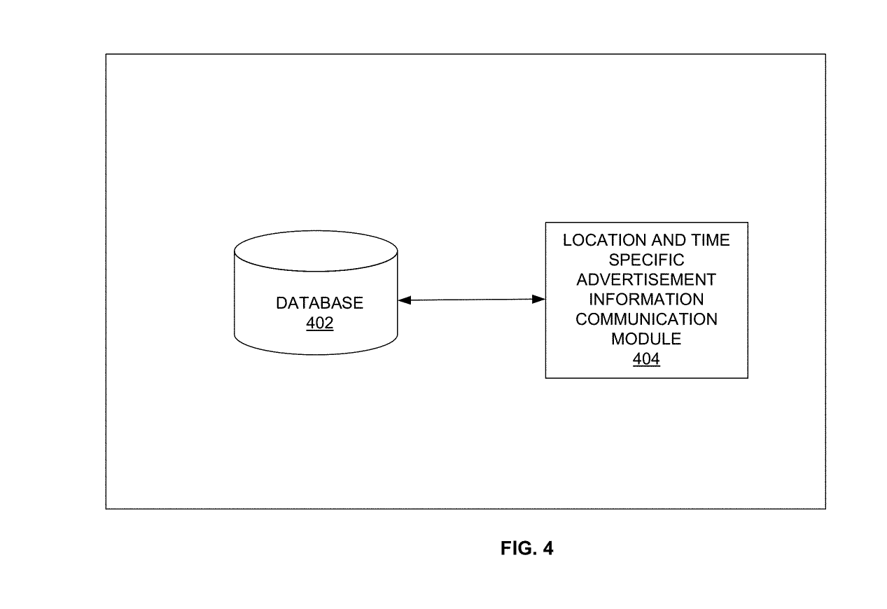

FIG. 4 illustrates an exploded view of the user targeted advertisement delivery system 106 configured in the one or more advertiser devices 108A-N of FIG. 1 according to an embodiment herein. The user targeted advertisement delivery system 106, of the one or more advertiser devices 108A-N, includes a database 402 and a location and time specific advertisement information communication module 404. The location and time specific advertisement information communication module 404 is configured to communicate one or more advertisements to the parking server 110 by the one or more advertisers 112A-N via the network 114. In one embodiment, the one or more advertiser devices 108A-N is a mobile device with a WiFi or 3G/4G/5G connection or any such data connection. For example a live feed or photo of the restaurant (i.e. one or more advertisers 112A-N) may be taken/recorded by the one or more advertiser devices 108A-N and communicates the recorded information to the user device 104 along with the one or more advertisements.

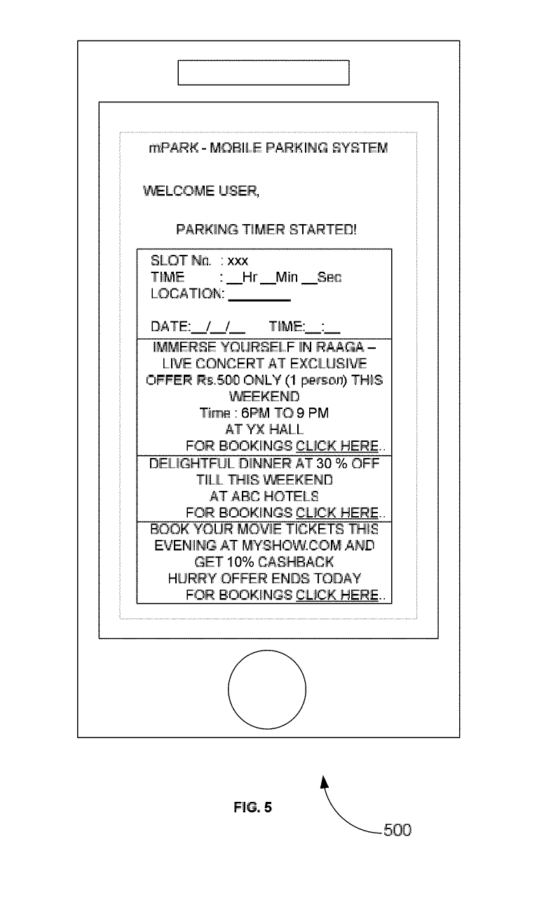

FIG. 5 illustrates the user interface view 500 of the targeted advertisement notification receiving module 208 of the user device 104 of FIG. 1 according to an embodiment herein. The user interface view 500 of the targeted advertisement notification receiving module 208 of the user device 104 provides an option to the user 102 to receive the welcome note with the one or more targeted advertisements of the user targeted advertisement delivery system 106 of the parking server 110. In one embodiment, the user 102 receives one or more targeted advertisements of the one or more advertisers 112A-N when the user 102 parks his/her vehicle in the micro and macro location, the time of the day, the day of the week or the calendar event preferred by the one or more advertisers 112A-N.

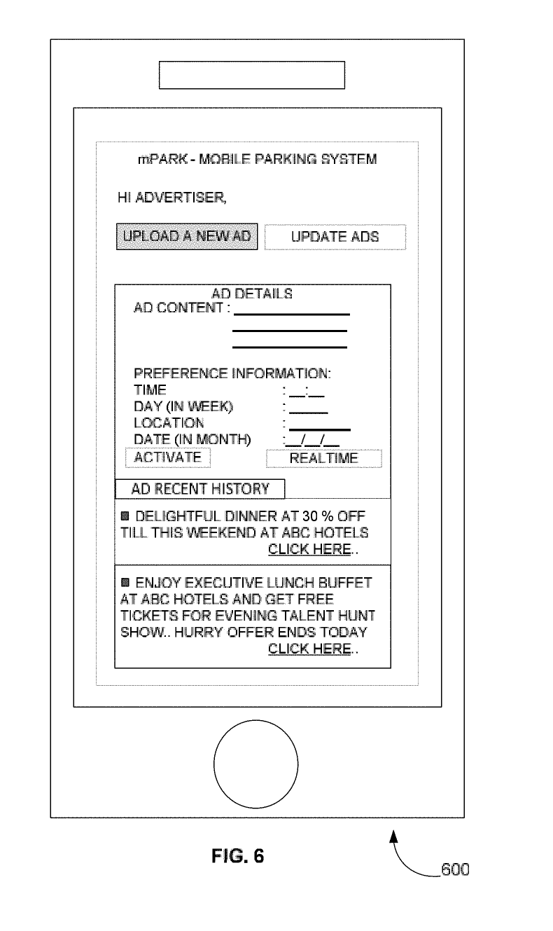

FIG. 6 illustrates a user interface view 600 of the location and time specific advertisement information communication module 404 of the one or more advertisers 112A-N of FIG. 1 according to an embodiment herein. The user interface view 600 of the location and time specific advertisement information communication module 404 of the one or more advertisers 112A-N provides an option to the one or more advertiser 112A-N to communicate the one or more advertisements to the user device 104 through the parking server 110. In one embodiment, the one or more advertisers 112A-N communicate one or more advertisement information to the parking server 110. The advertisement information includes at least one of the micro and macro location, the time of the day, the day of the week the calendar event at which the one or more advertisers 112A-N prefer to deliver one or more advertisements, and the duration of parking.

In one embodiment, the user interface view 600 of the location and time specific advertisement information communication module 404 allows the one or more advertisers 112A-N to update and deliver one or more advertisements to the user device 102 through the parking server 110. In another embodiment, the user interface view 600 of the location and time specific advertisement information communication module 404 allows the one or more advertisers 112A-N to edit one or more advertisements to the user device 104 through the parking server 110. In yet another embodiment, the user interface view 600 of the location and time specific advertisement information communication module 404 allows the one or more advertisers 112A-N to edit one or more advertisements information through the parking server 110. In yet another embodiment, the user interface view 600 of the location and time specific advertisement information communication module 404 allows the one or more advertisers 112A-N to deliver one or more advertisements in real-time to the user device 104 through the parking server 110.

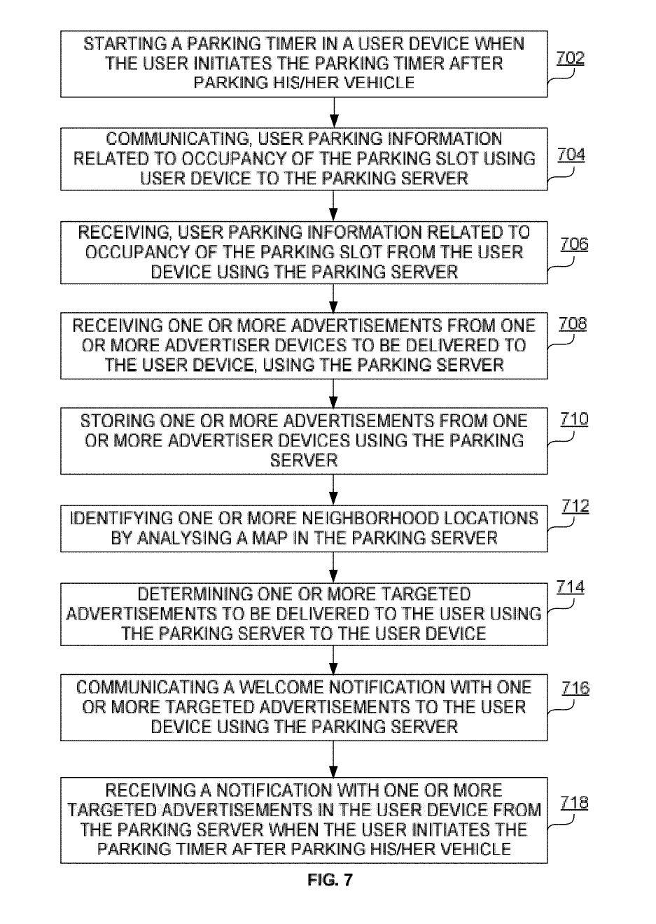

FIG. 7 is a flow diagram illustrating a method of delivering one or more targeted advertisements to a user device 104 through a parking server 110 using a user targeted advertisement delivery system 106 of FIG. 1 according to an embodiment herein. At step 702, a parking duration is selected from a parking timer in the user device 104 when a user 102 parks his/her car. At step 704, a user parking information related to occupancy of a parking slot using the user device 104 is communicated to the parking server 110. At step 706, the user parking information related to occupancy of the parking slot from the user device 104 is received by the parking server 110. At step 708, one or more advertisements from one or more advertiser devices 108A-N is received by the parking server 110 that is to be delivered to the user device 104. At step 710, one or more advertisements from the one or more advertiser devices 108A-N are stored in the advertisement database 302 of the parking server 110. At step 712, one or more micro and macro locations are identified by analyzing a map in the parking server 110. In one embodiment, the map is stored in memory unit of the parking server 110. At step 714, the one or more targeted advertisements to be delivered to the user device 104 are determined by the parking server 110. In one embodiment, one or more targeted advertisements to be delivered to the user device 104 is determined based on (i) the location of the user device, and at least one of (a) the one or more micro and macro locations, (b) the time at which the user device occupies the parking slot, (b) the profile of the user, and (ii) the micro and macro location at which the one or more advertisers prefer to deliver the one or more advertisements, and at least one of (a) the time of the day, (b) the day of the week, (c) the calendar event at which the one or more advertisers prefer to deliver the one or more advertisements, and (d) duration of parking that is selected. At step 716, a notification with the one or more targeted advertisements is communicated to the user device 104 from the parking server 110. At step 718, the notification with the one or more targeted advertisements is received in the user device 104 from the parking server 110 when the user 102 selects the parking duration from the parking timer after parking his/her vehicle.

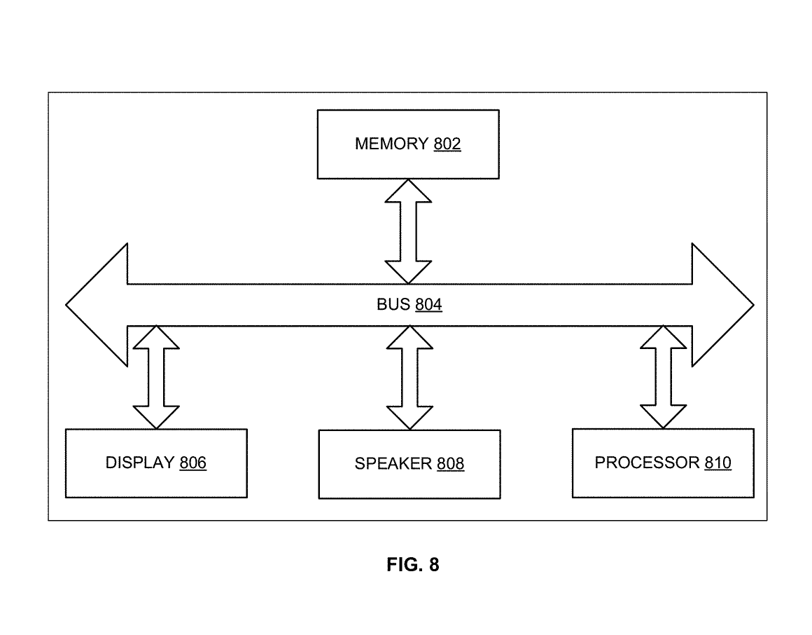

FIG. 8 illustrates an exploded view 800 of the personal communication device having an a memory 802 having a set of computer instructions, a bus 804, a display 806, a speaker 808, and a processor 810 capable of processing a set of instructions to perform any one or more of the methodologies herein, according to an embodiment herein. In one embodiment, the receiver may be the personal communication device. The processor 810 may also enable digital content to be consumed in the form of video for output via one or more displays 806 or audio for output via speaker and/or earphones 808. The processor 810 may also carry out the methods described herein and in accordance with the embodiments herein.

Digital content may also be stored in the memory 802 for future processing or consumption. The memory 802 may also store program specific information and/or service information (PSI/SI), including information about digital content (e.g., the detected information bits) available in the future or stored from the past. A user of the personal communication device may view this stored information on display 806 and select an item of for viewing, listening, or other uses via input, which may take the form of keypad, scroll, or other input device(s) or combinations thereof. When digital content is selected, the processor 810 may pass information. The content and PSI/SI may be passed among functions within the personal communication device using the bus 804.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

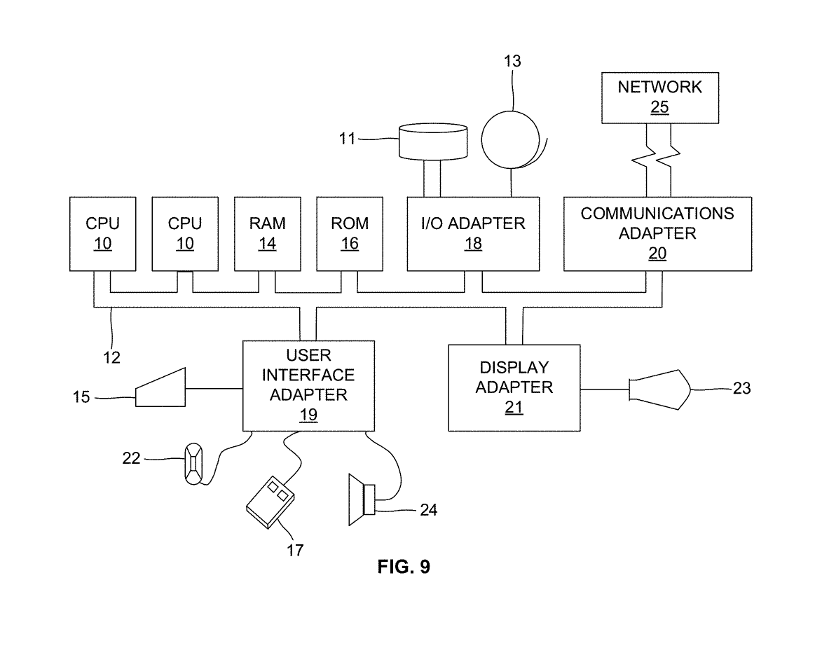

A representative hardware environment for practicing the embodiments herein is depicted in FIG. 9. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The user targeted advertisement delivery system 106 allows the one or more advertisers from the local area to promote their products and services in an affective and efficient manner by targeting their advertisements. The system is easy to implement and performed through the mobile parking payment applications. The businesses may be able to improve their business by announcing their presence and increasing top of the mind recall. Deals and goodies could be offered by the businesses to target and attract customers. These deals may include free parking paid for by the business. In this way, the provided system could be a win-win situation for the customer who gets deals, businesses which see their product and services and municipalities which get its due share of revenue.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A user targeted advertisement delivery system 106 for delivering a plurality of targeted advertisements to a user device 104 through a parking server 110, said parking server 110 comprising:
a memory unit that stores (a) a set of modules, and (b) an advertisement database 302; and
a processor which executes said set of modules, wherein said set of modules comprises:
a user parking information receiving module 304 configured to receive user parking information related to occupancy of a parking slot by a user 102 from said user device 104, wherein said user parking information comprises (a) a location of said user device 104, and/or a location of said parking slot and lot that is occupied, (b) a time at which said user 102 occupies said parking slot, and (c) a profile of said user 102;
a location and time specific advertisement information receiving module 306 configured to receive a plurality of advertisements from a plurality of advertiser devices 108A-N, wherein said plurality of advertisements comprises advertisement information selected based on at least one of (i) a micro and macro location, (ii) a time of a day, (iii) a day of a week, (iv) a calendar event at which a plurality of advertisers 112A-N prefer to deliver said plurality of advertisements, and (v) a duration of parking, wherein said plurality of advertisements are categorized based on said micro and macro location at which said plurality of advertisers 112A-N prefer to deliver said plurality of advertisements and stored in said advertisement database 302;
a micro and macro location information identification module 308 configured to identify a plurality of micro and macro locations by analyzing a map or a google map, wherein said map is stored in said memory unit;
a targeted advertisement determining module 310 configured to determine a plurality of targeted advertisements for said user 102 based on (i) said location of said user device 104, and/or said location of said parking slot and lot, and at least one of (a) said plurality of micro and macro locations, (b) said time at which said user device 104 occupies said parking slot, and (c) said profile of said user 102, and (ii) said micro and macro location at which said plurality of advertisers 112A-N prefer to deliver said plurality of advertisements, and at least one of (a) said time of said day, (b) said day of said week, (c) said calendar event at which said plurality of advertisers 112A-N prefer to deliver said plurality of advertisements and (d) said duration of parking; and
a targeted advertisement notification communicating module 312 configured to communicate a welcome notification with said plurality of targeted advertisements to said user device 104.

2. The system 106 as claimed in claim 1, wherein said user device 104 comprises:
a parking timer module 204 configured to select a parking duration from a parking timer, wherein said parking timer comprises at least one of (i) parking timer blocks, and (ii) a start/stop timer to select said parking duration;
a user parking information communicating module 206 configured to communicate said user parking information related to occupancy of said parking slot to said parking server 110; and
a targeted advertisement notification receiving module 208 configured to receive said notification with said plurality of targeted advertisements from said parking server 110 when said parking duration is selected.

3. The system 106 as claimed in claim 1, wherein said plurality of advertiser devices 108A-N comprises a location and time specific advertisement information communication module 404 that is configured to communicate said plurality of advertisements to said parking server 110.

4. A user targeted advertisement delivery system 106 for delivering a plurality of targeted advertisements, comprising:
a user device 104 that comprises
a parking timer module 204 configured to select a parking duration from a parking timer, wherein said parking timer comprises at least one of (i) parking time blocks, and/or (ii) a start/stop timer to select said parking duration;
a user parking information communicating module 206 that is configured to communicate user parking information related to occupancy of said parking slot by said user 102 to a parking server 110, wherein said user parking information comprises (a) a location of said user device 104, and/or a location of said parking slot and lot, (b) a time at which said user 102 occupies said parking slot, and (c) a profile of said user 102; and
said parking server 110 that comprises
a user parking information receiving module 304 configured to receive said user parking information related to occupancy of said parking slot from said user device 104;
a location and time specific advertisement information receiving module 306 configured to receive a plurality of advertisements from a plurality of advertiser devices 108A-N, wherein said plurality of advertisements comprises advertisement information selected from at least one of (i) a micro and macro location, (ii) a time, (iii) a day of a week, (iv) a calendar event at which a plurality of advertisers 112A-N prefer to deliver said plurality of advertisements, and (v) a duration of parking, wherein said parking server 110 comprises an advertisement database 302 that (i) categorizes said plurality of advertisements based on said micro and macro location at which said plurality of advertisers 112A-N prefer to deliver said plurality of advertisements, and (ii) store said plurality of advertisements in said advertisement database 302;
a micro and macro location information identification module 308 configured to identify a plurality of micro and macro locations by analyzing a map, wherein said parking server 110 comprises a memory unit that stores said map;
a targeted advertisement determining module 310 configured to determine a plurality of targeted advertisements for said user 102 based on (i) said location of said user device 104, and/or said location of said parking slot and lot, and at least one of (a) said plurality of micro and macro locations, (b) said time at which said user device 104 occupies said parking slot, and (c) said profile of said user 102, and (ii) said micro and macro location at which said plurality of advertisers 112A-N prefer to deliver said plurality of advertisements, and at least one of (a) said time of said day, (b) said day of said week, (c) said calendar event at which said plurality of advertisers 112A-N prefer to deliver said plurality of advertisements, and (d) duration of parking; and
a targeted advertisement notification communicating module 312 configured to communicate notifications with said plurality of targeted advertisements to said user device 104,
wherein said user device 104 comprises a targeted advertisement notification receiving module 208 configured to receive said notifications with said plurality of targeted advertisements from said parking server 110 when said parking duration is selected.

5. The system as claimed in claim 4, wherein said plurality of advertiser devices 108A-N comprises a location and time specific advertisement communication module 404 that is configured to communicate said plurality of advertisements to said parking server 110.

6. The system as claimed in claim 4, wherein said location of said user device 104 is determined based on at least one of (a) a global positioning system (GPS) associated with said user device 104, and (b) a location information associated with said parking slot that is occupied by said user 102.

7. The system as claimed in claim 4, wherein said location and time specific advertisement information communication module 404 communicates said plurality of advertisements in real-time to said parking server 110.

8. The system as claimed in claim 4, wherein said location and time specific advertisement communication module 404 updates said plurality of advertisements that are stored in said advertisement database 302 of said parking server 110 in real-time.

9. A method for delivering said plurality of targeted advertisements to a user device 104, comprising:
selecting, a parking duration from a parking timer in said user device 104 by a user 102 after parking his/her vehicle in a parking slot, wherein said parking timer comprises at least one of (i) parking timer blocks, and (ii) a start/stop timer to select said parking duration;
communicating, using said user device 104, user parking information related to occupancy of said parking slot to a parking server 110, wherein said user information comprises (a) a location of said user device 104, and/or a location of said parking lot and slot, (b) a time at which said user 102 occupies said parking slot, and (c) a profile of said user 102;
receiving, using said parking server 110, said user parking information related to occupancy of said parking slot from said user device 104;
receiving, using said parking server 110, a plurality of advertisements from a plurality of advertiser devices 108A-N, wherein said plurality of advertisements comprises advertisement information selected from at least one of (i) a micro and macro location, (ii) a time of a day, (iii) a day of a week, (iv) a calendar event at which a plurality of advertisers 112A-N prefer to deliver said plurality of advertisements, and (v) duration of parking;
storing, at said parking server 110, said plurality of advertisements, wherein said plurality of advertisements are categorized based on said micro- and macro location at which said plurality of advertisers 112A-N prefer to deliver said plurality of advertisements;
identifying, at said parking server 110, a plurality of micro and macro location by analyzing a map that is stored in said parking server 110;
determining, at said parking server 110, said plurality of targeted advertisements for said user 102 based on (i) said location of said user device 104, and/or a location of said parking lot and slot, and at least one of (a) said plurality of micro and macro locations, (b) said time at which said user device 104 occupies said parking slot, and (c) said profile of said user 102, and (ii) said micro and macro location at which said plurality of advertisers 112A-N prefer to deliver said plurality of advertisements, and at least one of (a) said time of said day, (b) said day of the week, (c) said calendar event at which said plurality of advertisers 112A-N prefer to deliver said plurality of advertisements, and (d) duration of parking;
communicating, using said parking server 110, a welcome notification with said plurality of targeted advertisements to said user device 104; and
receiving, using said user device 104, said welcome notification with said plurality of targeted advertisements from said parking server 110 when said user selects said parking duration.

10. The method as claimed in claim 9, further comprising the step of communicating, using a plurality of advertiser devices 108A-N, said plurality of advertisements to said parking server 110.
